(19) United States
(12) Patent Application Publication
(10) Pub. No.: US 2009/0126005 A1
(43) Pub. Date: May 14, 2009

(54) METHOD, APPARATUS AND SYSTEM FOR MANAGING MALICIOUS-CODE SPREADING SITES USING FIREWALL

(76) Inventors: Min Sik Kim, Daejeon (KR); Jung Gil Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/102,283

(22) Filed: Apr. 14, 2008

(30) Foreign Application Priority Data
Nov. 8, 2007 (KR) 10-2007-0113974

(51) Int. Cl. G06F 21/00

(52) U.S. Cl. 726/14

(57) ABSTRACT

A method for managing a website is provided in which a web page including a malicious code is classified to be registered in a network firewall, so that a network terminal is prevented from being accessed to the web page including a malicious code.

The method for managing a malicious-code spreading site using a firewall includes: analyzing a currently accessed website to determine whether the website includes a malicious code or not; when it is determined that the currently accessed website includes a malicious code, registering the website as a malicious-code spreading site; when a network terminal in a firewall requests for access to a website, determining whether the website is registered as a malicious-code spreading site; and, when the access requested website is registered as a malicious-code spreading site, preventing the access to the website. Accordingly, a web page including a malicious code is classified to be registered in a network firewall, so that a network terminal can be protected from a malicious code by preventing the network terminal from accessing the web page including a malicious code.

### CROSS-REFERENCE TO RELATED APPLICATION

This application claims priority to and the benefit of Korean Patent Application No. 2007-113974, filed Nov. 8, 2007, the disclosure of which is incorporated herein by reference in its entirety.

### BACKGROUND

1. Field of the Invention

The present invention relates to a method for managing web sites, and more particularly, to a method for preventing user access to web sites including a malicious code.

2. Discussion of Related Art

Recent rapid development and widespread use of information systems and the Internet have increased importance of information distributed via Internet web sites. The information distributed via web sites is threatened by an exploit or malicious code, which may pose a threat to confidentiality, integrity, and availability of the information.

To prevent a malicious code from spreading via web sites, conventional web service providers have concentrated on operating security systems for their services.

However, if a user terminal accesses a web site through some other method than the web service provider that operates the security system, it may be infected with a fatal malicious code included in the web site.

Therefore, a method for blocking access to a web site including a malicious code at a network level is required.

### SUMMARY OF THE INVENTION

The present invention is directed to a method for preventing a network terminal from accessing web pages including a malicious code by classifying the web pages including the malicious code and registering the classified results in a network firewall.

Additional objects and advantages of the present invention will be set forth in part in the description which follows and, in part, will be obvious from the description, or may be learned by practice of the invention.

One aspect of the present invention provides a method for managing malicious-code spreading sites using a firewall, including: analyzing a currently accessed web site to determine whether a malicious code is included in the web site; if the malicious code is included in the currently accessed web site, registering the web site as a malicious-code spreading site; when a network terminal in a firewall requests for access to a web site, determining whether the web site is registered as a malicious-code spreading site; and, when the access requested web site is registered as a malicious-code spreading site, preventing the access to the web site.

Another aspect of the present invention provides an apparatus for managing a malicious-code spreading site using a firewall, which prevents a network terminal in the firewall from accessing a web site including a malicious code, including: a malicious code detection unit for receiving a URL of a web site likely to include a malicious code from a user terminal, accessing the web site via the received URL, and determining whether the malicious code is included in the web site; and a malicious-code spreading site managing unit for registering the web site as a malicious-code spreading site to output a URL of the malicious-code spreading site to at least one firewall when it is determined that the web site includes a malicious code.

Still another aspect of the present invention provides a system for managing malicious-code spreading sites using a firewall, including: a firewall; a network terminal in the firewall; and malicious-code spreading site managing apparatus for registering and managing a web sites including a malicious code as a malicious-code spreading site and being communicable with the network terminal. The malicious-code spreading site managing apparatus includes: a malicious code detection unit for receiving a URL of a website likely to include a malicious code from the network terminal, and then determining whether the website includes a malicious code or not; and a malicious-code spreading site managing unit for registering the website as a malicious-code spreading site, and then outputting a URL of the malicious-code spreading site to at least one firewall when it is determined that the website includes a malicious code. The firewall includes: a storage unit for storing the URL of the malicious-code spreading site; and a malicious-code spreading site prevention unit for preventing the network terminal from accessing the website when a URL of a web page that is requested by the network terminal is stored in the storage unit.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a schematic diagram of a system for managing malicious-code spreading sites according to an exemplary embodiment of the present invention;

FIG. 2A is a block diagram of a network terminal according to an exemplary embodiment of the present invention;

FIG. 2B is a block diagram illustrating the configuration of a malicious-code spreading site managing apparatus according to an exemplary embodiment of the present invention;

FIG. 2C is a block diagram of a firewall according to an exemplary embodiment of the present invention;

FIG. 3 is a flowchart illustrating a method for managing a malicious-code spreading site according to an exemplary embodiment of the present invention; and

FIG. 4 is a flowchart illustrating a method for updating a malicious-code spreading site according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the exemplary embodiments disclosed below, but can be implemented in various forms. Therefore, the following exemplary embodiments are described in order for this disclosure to be complete and enable to those of ordinary skill in the art to embody and practice the present invention.

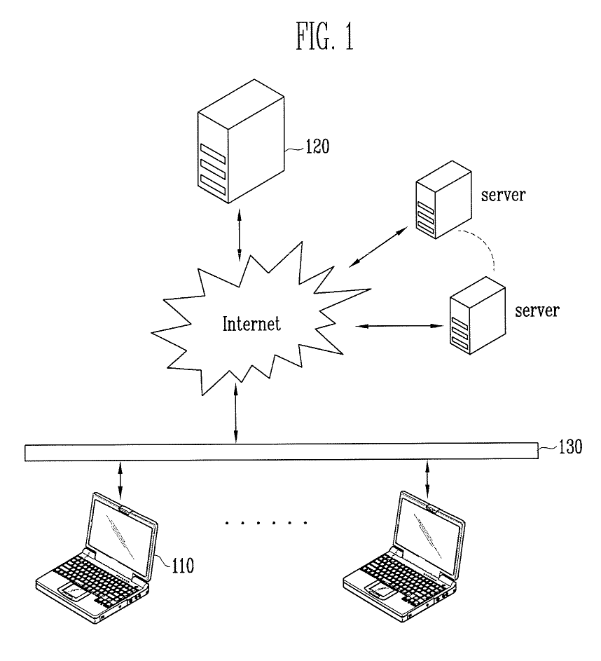

FIG. 1 is a schematic diagram of a system for managing malicious-code spreading sites using a firewall according to an exemplary embodiment of the present invention. Referring to FIG. 1, the system for managing malicious-code spreading sites according to an exemplary embodiment of the present invention includes a network terminal 110, a malicious-code spreading site managing apparatus 120, and a firewall 130. The configuration and operation of the system for managing malicious-code spreading sites using a firewall according to an exemplary embodiment of the present invention will now be described below with reference to FIG. 1.

The network terminal 110 according to an exemplary embodiment of the present invention may be any one of various electronic devices capable of accessing web sites via the Internet, including computers, mobile telephones, personal digital assistants (PDAs), and the like. When accessing the web site and determining that the web site is likely to include a malicious code, the network terminal 110 outputs a Uniform Resource Locator (URL) of the web site to the malicious-code spreading site managing apparatus 120. Here, the web site is determined to be likely to include a malicious code when a processing speed of the network terminal 110 becomes lower or an unsolicited program is executed.

The URL may be automatically output by software installed in the network terminal 110 or manually by a user when the terminal is likely to be infected with a malicious code.

The malicious-code spreading site managing apparatus 120 according to an exemplary embodiment of the present invention accesses the web site likely to include a malicious code using its URL received from the terminal 110, and determines whether the malicious code is included in the web site. If the malicious code is included in the web site, the malicious-code spreading site managing apparatus 120 outputs the URL of the web site to the firewall 130. The malicious-code spreading site managing apparatus 120 may determine whether the malicious code is included in the web site by remotely accessing the web site and checking for symptoms or by using a program such as a vaccine program.

The firewall 130 of the present invention is installed in a place where an internal network is connected to an external network, such as the Internet, and prevents a user from accessing a web page that is determined to include a malicious code.

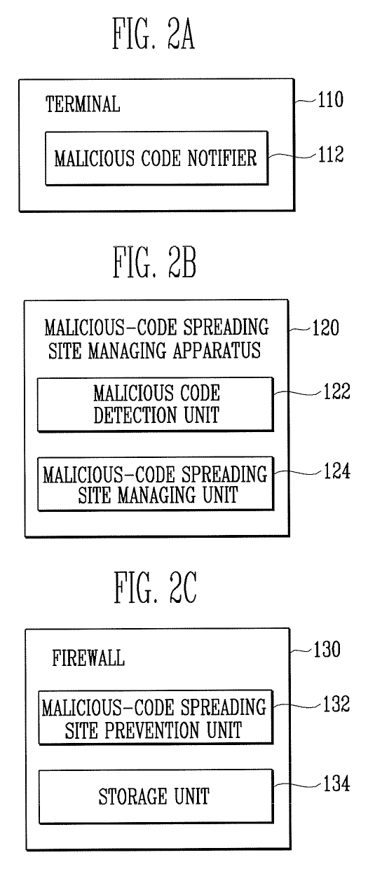

The configuration of the system for managing malicious-code spreading sites using a firewall according to an exemplary embodiment of the present invention will be described in detail below with reference to FIG. 2.

FIG. 2A is a block diagram of a network terminal 110 according to an exemplary embodiment of the present invention. Referring to FIG. 2, the network terminal 110 of the present invention includes a malicious code notifier 112. The configuration and operations of the network terminal 110 according to an exemplary embodiment of the present invention will now be described in greater detail with reference to FIG. 2A.

The malicious code notifier 112 of the present invention analyzes a web site currently accessed by the network terminal 110 to determine whether the malicious code is included in the web site. If it is determined that the malicious code is included in the currently accessed web site, the malicious code notifier 112 outputs a URL of the web site to the malicious-code spreading site managing apparatus 120. If the malicious code notifier 112 is likely to be included in the currently accessed web page, the malicious code notifier 112 may also output the URL of the currently accessed web page to the malicious-code spreading site managing apparatus 120 in response to an instruction from the user.

While not illustrated, a network terminal 110 according to an exemplary embodiment of the present invention may include a receiver for receiving the instruction from the user, and a display unit for displaying the website search results, etc.

FIG. 2B is a block diagram illustrating the configuration of the malicious-code spreading site managing apparatus 120 according to an exemplary embodiment of the present invention. Referring to FIG. 2B, the malicious-code spreading site managing apparatus 120 according to an exemplary embodiment of the present invention includes a malicious code detection unit 122, and a malicious-code spreading site managing unit 124. The malicious-code spreading site managing apparatus 120 according to an exemplary embodiment of the present invention will now be described in detail with reference to FIG. 2B.

The malicious code detection unit 122 according to an exemplary embodiment of the present invention receives the URL of the web site likely to include a malicious code from the network terminal 110, accesses the web site via the received URL, determines whether the malicious code is included in the web site, and outputs the determination result to the malicious-code spreading site managing unit 124.

Also, the malicious code detection unit 122 according to an exemplary embodiment of the present invention periodically checks web sites registered as malicious-code spreading sites to determine whether or not the malicious code is still included in the site. The malicious code detection unit 122 outputs the determination result to the malicious-code spreading site managing unit 124.

When the malicious code detection unit 122 determines that the malicious code is included in the web site, the malicious-code spreading site managing unit 124 according to an exemplary embodiment of the present invention registers and stores the web site as a malicious-code spreading site and outputs the URL of the malicious-code spreading site to the firewall 130.

When the malicious code detection unit 122 periodically checks the web site registered as a malicious-code spreading site and determines that the malicious code is no longer included in the registered web site, the malicious-code spreading site managing unit 124 according to an exemplary embodiment of the present invention unregisters the web site and outputs the URL of the unregistered web site to the firewall 130. Alternatively, the malicious-code spreading site managing unit 124 according to an exemplary embodiment of the present invention may produce a malicious-code spreading site list, update the malicious-code spreading site list every check, and output the updated malicious-code spreading site list to the firewall 130, instead of outputting the URL of the unregistered web site to the search engine.

FIG. 2C is a block diagram of a firewall 130 according to an exemplary embodiment of the present invention. Referring to FIG. 2C, the firewall 130 according to an exemplary embodiment of the present invention includes a malicious-code spreading site prevention unit 132, and a storage unit 134. The firewall 130 according to an exemplary embodiment of the present invention will now be described in detail with reference to FIG. 2C.

When the malicious-code spreading site prevention unit 132 receives a request for access to a web page, a URL of which is stored in the storage unit 134 that stores a URL of a malicious-code spreading site, from a network terminal 110, it prevents the network terminal from accessing the web site.

The storage unit 134 stores the URL of the web site including a malicious code, which is received from a malicious-code spreading site managing apparatus 120.

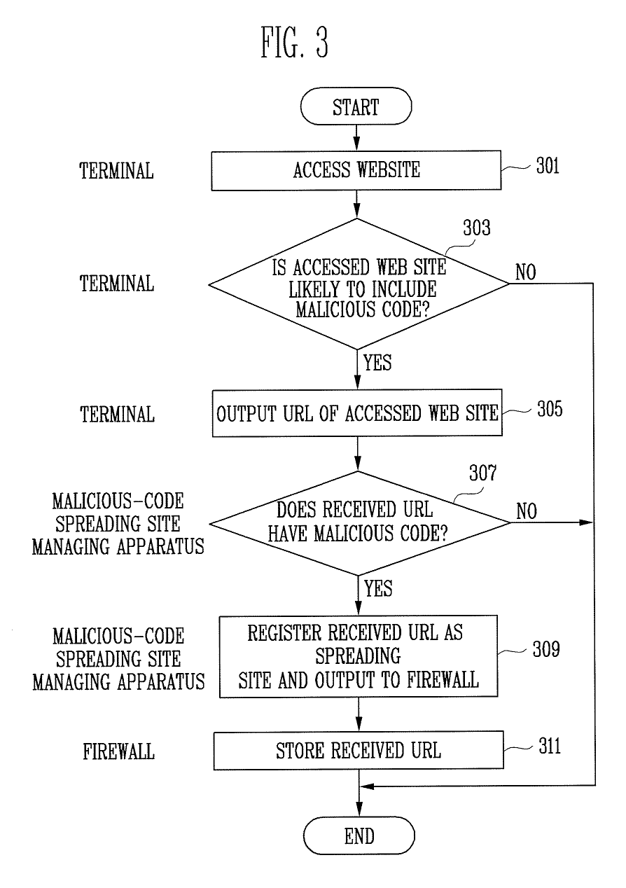

FIG. 3 is a flowchart illustrating a method for managing malicious-code spreading sites using a firewall according to an exemplary embodiment of the present invention. The method for managing the malicious-code spreading sites according to an exemplary embodiment will be described below with reference to FIG. 3.

In step 303, a malicious code notifier 112 of a network terminal 110 according to an exemplary embodiment of the present invention determines whether an accessed web site is likely to include a malicious code or not.

When the malicious code notifier 112 of the network terminal 110 determines that the currently accesses web site is likely to include a malicious code, the notifier outputs a URL of the currently accessed web site to a malicious-code spreading site managing apparatus 120 in step 305.

In step 307, a malicious code detection unit 122 of the malicious-code spreading site managing apparatus 120 receives the URL of the web site that is likely to include a malicious code from the network terminal 110 and accesses the web site according to the received URL to determine whether the web site includes a malicious code or not.

When the malicious code detection unit 122 determines that the web site includes a malicious code, a malicious-code spreading site managing unit 124 of the malicious-code spreading site managing apparatus 120 registers the web site as a malicious-code spreading site and outputs a URL of the registered web site to a firewall 130 in step 309.

In step 311, a malicious-code spreading site prevention unit 132 of the firewall 130 stores the URL of the web site in a storage unit 134.

Then, when the network terminal 110 requests for access to a web site via the firewall 130, the malicious-code spreading site prevention unit 132 determines whether a URL of the access requested web site is stored in the storage unit 134 or not, and when the URL of the access requested web site is stored in the storage unit 134, the access to the web site is prevented to protect the network terminal 110 from a malicious code.

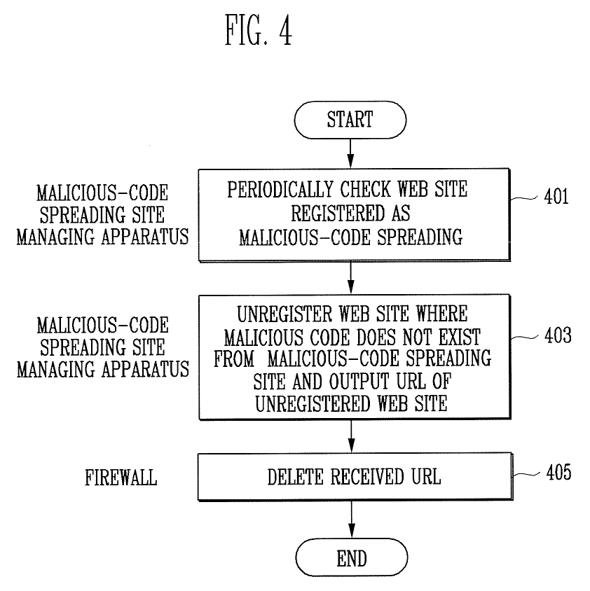

FIG. 4 is a flowchart illustrating a method for updating a malicious-code spreading site according to an exemplary embodiment of the present invention. The method for updating a malicious-code spreading site according to an exemplary embodiment of the present invention will be described below with reference to FIG. 4.

In step 401, a malicious code detection unit 122 of a malicious-code spreading site managing apparatus 120 according to an exemplary embodiment of the present invention periodically checks the web site registered as the malicious-code spreading site to determine whether or not the malicious code is still included in the web site.

In step 403, when it is determined in step 401 that the web site registered as the malicious-code spreading site no longer includes a malicious code, a malicious-code spreading site managing unit 124 of a malicious-code spreading site managing apparatus 120 unregisters the web site, and outputs the URL of the unregistered web site to a firewall 130.

In step 405, a malicious-code spreading site prevention unit 132 of the firewall 130 deletes the URL of the unregistered web site from the storage unit 134.

Meanwhile, in step 403, the malicious-code spreading site managing unit 124 may produce a malicious-code spreading site list, update the malicious-code spreading site list every check, and output the updated malicious-code spreading site list to the firewall 130, instead of outputting the URL of the unregistered web site to the search engine.

Here, the firewall 130 stores the malicious-code spreading site list received from the malicious-code spreading site managing unit 124 in the storage unit 134.

As described above, a web page including a malicious code is classified to be registered in a network firewall, so that a network terminal is prevented from accessing the web page including the malicious code to thereby be protected from a malicious code.

It will be understood by those of ordinary skill in the art that various changes in form and details may be made to the exemplary embodiments without departing from the spirit and scope of the present invention as defined by the following claims.

What is claimed is:

1. A method for managing a malicious-code spreading site using a firewall, comprising:
analyzing a currently accesses web site to determine whether the web site includes a malicious code or not;
when it is determined that the currently accesses web site includes a malicious code, registering the web site as a malicious-code spreading site;
when a network terminal in a firewall requests for access to a web site, determining whether the web site is registered as a malicious-code spreading site; and
when the access requested web site is registered as a malicious-code spreading site, preventing the access to the web site.

2. The method of claim 1, further comprising periodically checking the registered web site to unregister the web site from the malicious-code spreading site when a malicious code does not exist in the web site.

3. An apparatus for managing a malicious-code spreading site using a firewall, which prevents a network terminal in the firewall from accessing to a web site including a malicious code, comprising:
a malicious code detection unit for receiving a URL of a web site likely to include a malicious code from a user terminal, and then accessing to the web site according to the received URL to determine whether the web site includes a malicious code or not; and
a malicious-code spreading site managing unit for registering the web site as a malicious-code spreading site to output a URL of the malicious-code spreading site to at least one firewall when it is determined that the web site includes a malicious code.

4. The apparatus of claim 3, wherein the malicious code detection unit periodically checks the web site that is registered as a malicious-code spreading site, and the malicious-code spreading site managing unit unregisters the web site from the malicious-code spreading site and outputs a URL of the unregistered web site to at least one firewall when a malicious code does not exist in the web site that is registered as a malicious-code spreading site as a result of the check.

5. The apparatus of claim 3, wherein the malicious code detection unit periodically checks the web site that is registered as a malicious-code spreading site, and the malicious-code spreading site managing unit produced a list of the web sites registered as a malicious-code spreading site and updates the list according to the result of the check to output to the at least one firewall.

6. A system for managing a malicious-code spreading site using a firewall, comprising:
a firewall;
a network terminal in the firewall; and
a malicious-code spreading site managing apparatus for registering and managing a web site including a malicious code as a malicious-code spreading site and being communicable with the network terminal,
wherein the malicious-code spreading site managing apparatus comprises:
a malicious code detection unit for receiving a URL of a web site likely to include a malicious code from the network terminal, and then determining whether the web site includes a malicious code or not; and
a malicious-code spreading site managing unit for registering the web site as a malicious-code spreading site, and then outputting a URL of the malicious-code spreading site to at least one firewall when it is determined that the web site includes a malicious code, and
the firewall comprises:
a storage unit for storing the URL of the malicious-code spreading site; and
a malicious-code spreading site prevention unit for preventing the network terminal from accessing the web site when a URL of a web page that is requested by the network terminal is stored in the storage unit.

7. The system of claim 6, wherein the terminal comprises a malicious code notifier for analyzing a currently accessed web page to output a URL of the currently accessed web page to the malicious-code spreading site managing unit when the web page likely to include a malicious code.

8. The system of claim 7, wherein the malicious code notifier receives an input from a user to alarm of a probability of the currently connected web page including a malicious code, and outputs the URL of the currently accessed web page to the malicious-code spreading site managing apparatus according to the input.

9. The system of claim 6, wherein the malicious code detection unit periodically checks the web site that is registered as a malicious-code spreading site, and the malicious-code spreading site managing unit unregisters the web site from the malicious-code spreading site and outputs a URL of the unregistered web site to the at least one firewall when a malicious code does not exist in the web site that is registered as a malicious-code spreading site as a result of the check.

10. The system of claim 6, wherein the malicious code detection unit periodically checks the web site that is registered as a malicious-code spreading site, and the malicious-code spreading site managing unit produces a list of web sites registered as malicious-code spreading sites and updates the list according to the check results to output the results to the at least one firewall.
